(19) United States
(12) Patent Application Publication
(10) Pub. No.: US 2019/0223445 A1
(43) Pub. Date: Jul. 25, 2019

(54) ANTIMICROBIAL GEOPOLYMER COMPOSITIONS

(71) Applicants: Dong-Kyun Seo, Chandler, AZ (US); Shelley Haydel, Mesa, AZ (US)

(72) Inventors: Dong-Kyun Seo, Chandler, AZ (US); Shelley Haydel, Mesa, AZ (US)

(21) Appl. No.: 16/317,428

(22) PCT Filed: Jul. 13, 2017
(86) PCT No.: PCT/US2017/041965

§ 371 Date: Jan. 11, 2019

Related U.S. Application Data
(60) Provisional application No. 62/362,110, filed on Jul. 14, 2016.

(51) Int. Cl. A01N 59/06; A01N 59/20; C04B 38/02; C04B 38/00; C04B 24/04; C04B 14/04; A01N 25/08

(52) U.S. Cl. CPC A01N 59/06; A01N 59/20; C04B 38/02; C04B 28/006; C04B 24/045; C04B 14/047; A01N 25/08; C04B 38/0054

(57) ABSTRACT

An antimicrobial composition including porous aggregates of alumi-nosilicate nanoparticles. The porous aggregates contain one or more kinds of metals selected among alkaline earth metals, rare earth metals,m Mn, Fe, Co, Ni, Ag, Cu, Zn, Hg, Sn, Pb, Bi, Cd, Cr, and Tl.

### CROSS-REFERENCE TO RELATED APPLICATION

This application claims the benefit of U.S. Application Ser. No. 62/362,110 entitled “ANTIMICROBIAL GEOPOLYMER COMPOSITIONS” and filed on Jul. 14, 2016, which is incorporated by reference herein in its entirety.

### STATEMENT OF GOVERNMENT INTEREST

This invention was made with government support under R21 AI121733 awarded by the National Institutes of Health. The government has certain rights in the invention.

### TECHNICAL FIELD

This invention relates to antimicrobial geopolymer compositions, and in particular to submicron-sized aggregates of geopolymer nanoparticles with zeolitic micropores including one or more alkaline earth metals, rare earth metals, or transition metals and having a high efficacy in antimicrobial applications.

### BACKGROUND

An antimicrobial is an agent that kills microorganisms or inhibits their growth. The term “antimicrobials” include all agents that act against all types of microorganisms including bacteria (antibacterial), viruses (antiviral), fungi (antifungal) and protozoa (antiprotozoal). Due to increasing antibiotic resistance, there has recently been a renewed interest in antimicrobial agents. In one example, methicillin-resistant Staphylococcus aureus (MRSA) is an increasingly dangerous and antibiotic-resistant bacterial pathogen. Healthcare acquired MRSA (HA-MRSA) mainly causes systemic infections such as bacteremia, pneumonia, or surgical site infections, and is contracted while the patient is in a healthcare setting. Community acquired MRSA (CA-MRSA) mainly causes skin and soft tissue infections, including necrotizing fasciitis. Identifying complementary therapeutic strategies and preventive measures for combatting bacteria, in particular antibiotic-resistant bacteria, are crucial, as the antibiotic resistance crisis continues to worsen.

### SUMMARY

This disclosure is related to submicron-sized porous aggregates of geopolymer nanoparticles, in particular the geopolymer nanoparticles with zeolitic micropores, including at least one of alkaline earth metals, rare earth metals, Mn, Fe, Co, Ni, Ag, Cu, Zn, Hg, Sn, Pb, Bi, Cd, Cr, and Tl, and having a high efficacy in antimicrobial applications. The nanoparticles may provide effective ion release, while the submicron-sized porous aggregates are more suitable than nanoparticles for handling and composite preparation. The resulting porous aggregates may show faster ion release rates and/or higher antibacterial efficacy than conventional ion-exchanged zeolites.

In a general aspect, an antimicrobial composition includes porous aggregates. The porous aggregates include aluminosilicate nanoparticles and contain one or more of alkaline earth metals, rare earth metals, Mn, Fe, Co, Ni, Ag, Cu, Zn, Hg, Sn, Pb, Bi, Cd, Cr, and Tl in metallic form, ionic form, or a combination thereof.

Implementations of the first general aspect may include one or more of the following features.

In some implementations, an average particle size of the aluminosilicate nanoparticles is between about 5 nm and about 100 nm. A majority of the pores between the aluminosilicate nanoparticles in the porous aggregates may have a pore width between about 2 nm and about 100 nm. A majority of the porous aggregates may have a particle size between about 50 nm and about 10 μm. A majority of the porous aggregates may have a particle size between about 50 nm and about 1 μm. The antimicrobial composition may include about 0.05 to about 99% by weight of the porous aggregates.

In some implementations, the mesopore volume of the porous aggregates is at least about 0.05 cc/g, at least about 0.1 cc/g, at least about 0.2 cc/g, or at least about 0.3 cc/g on the Barrett, Joyner and Halenda (BJH) cumulative pore volume from the desorption branch of the N₂ sorption isotherm, where the mesopore volume is the total pore volume of the pores having a pore width from about 2 to about 100 nm. In some implementations, the mesopore volume of the porous aggregates contributes at least about 10%, at least about 30%, at least about 50%, at least about 70%, or at least about 90% of the total pore volume of the aggregates from the pores having a pore width between about 2 nm and about 100 nm based on the Barrett, Joyner and Halenda (BJH) cumulative pore volume from the desorption branch of the N₂ sorption isotherm.

In some implementations, the specific external surface area of the porous aggregates is between about 10 m²/g and about 300 m²/g, where the specific external surface area of the porous aggregates is the total specific surface area minus the specific micropore surface area. The specific micropore surface area of the porous aggregates may between about 100 m²/g and about 700 m²/g, and the aluminosilicate defines zeolitic micropores.

In some implementations, the porous aggregates are formed during formation of the aluminosilicate nanoparticles, and the aluminosilicate nanoparticles of each of the porous aggregates are interconnected through chemical bonds throughout the formation of the porous aggregates.

The porous aggregates may be formed in a geopolymerization process. In one example, the porous aggregates are formed by providing a geopolymer resin containing up to about 85 mol % water; optionally keeping the geopolymer resin at a temperature up to about 60° C. for up to about a week; optionally heating the geopolymer resin in a closed container at a temperature up to about 120° C. for up to about a week to yield a semi-liquid or a semi-solid; treating the semi-liquid or the semi-solid to form a dispersion or suspension including the porous aggregates and reducing the pH of the dispersion or suspension to a range from about 3 to about 12; and optionally concentrating a solid component or collecting a solid product from the dispersion or suspension. The geopolymer resin may include organic molecules, such as an ester, an organic carboxylate, an organic carboxylic acid, or a combination thereof. The aluminosilicate nanoparticles may define zeolitic micropores, such as zeolitic micropores with a FAU, EMT or LTA structure.

In some implementations, the aluminosilicate nanoparticles include about 0.1 wt % to about 30 wt % of one or more metal ions selected from the group consisting of Ag, Cu, and Zn ions. In certain implementations, the porous aggregates contain silver, and the silver-containing porous aggregates release at least 33% of the contained silver within about 30 minutes when in contact with 0.9 wt % NaNO₃ solution flowing at 1.2 mL/min. In certain implementations, the porous aggregates contain silver, and the silver-containing porous aggregates release at least 33% of the contained silver within about 10 minutes when in contact with 0.9 wt % NaNO₃ solution flowing at 5.0 mL/min. In certain implementations, the porous aggregates contain silver, and the silver-containing porous aggregates show a minimum bactericidal concentration (MBC) value equivalent to no greater than about 0.3 μg or about 1 μg of Ag per mL within about 2 hours, or a MBC value equivalent to no greater than about 1 μg or about 10 μg of Ag per mL within about 24 hours for methicillin-resistant Staphylococcus aureus (MRSA). In certain implementations, the porous aggregates contain silver, and the silver-containing porous aggregates show a minimum inhibitory concentration (MIC) value equivalent to no greater than about 2 μg of Ag per mL within about 2 hours, or the MBC value equivalent to no greater than about 1 μg or about 10 μg of Ag per mL within about 24 hours for methicillin-resistant Staphylococcus aureus (MRSA). In certain implementations, the porous aggregates contain copper, and the copper containing porous aggregates show a minimum bactericidal concentration (MBC) value equivalent to no greater than about 10 μg or about 100 μg of Cu per mL within about 2 hours, or a MBC value equivalent to no greater than about 2000 μg of Cu per mL within about 24 hours for methicillin-resistant Staphylococcus aureus (MRSA).

In some implementations, the antimicrobial composition prevents growth and reproduction of bacteria selected from the group consisting of Acinetobacter lwoffii, Acinetobacter calcoaceticus, Acinetobacter baumannii, Acinetobacter spp., Aeromonas spp., Alcaligenes spp., Achromobacter spp., Bacillus anthracis, Bacillus cereus, Bacillus coagulans, Bacillus megaterium, Bacillus subtilis, Bacteriodes fragilis, Brevundimonas spp., Campylobacter jejuni, carbapenem-resistant Enterobacteriaceae, Citrobacter spp., Clostridium perfringens, Enterococcus faecium, Enterococcus faecalis, Escherichia coli including EHEC, EPEC, ETEC, EIEC, and EAEC, Klebsiella pneumoniae, Listeria monocytogenes, methicillin-resistant Staphylococcus aureus (MRSA), Micrococcus luteus, Mycobacterium absessus, Mycobacterium avium, Mycobacterium chelonae, Mycobacterium fortuitum, Mycobacterium marinum, Mycobacterium scrofulaceum, Mycobacterium ulcerans, Proteus mirabilis, Proteus vulgaris, Pseudoxanthomonas spp., Pseudomonas putida, Pseudomonas aeruginosa, Pseudomonas maculicola, P seudomanas chloror aphis, Pseudomonas flourescens, Pseudomonas tolaasii, Pseudomonas spp., Propionibacterium acnes, Nocardia brasiliensis, Nocardia asteroides, Nocardia globerula, Nocardia transvalensis, Nocardia spp., Stenotrophomonas maltophilia, Pantoea stewartii subspecies stewartii, Chryseobacterium balustinus, Duganella zoogloeoides, Chryseobacterium meningosepticum, Salmonella spp., Shigella spp. Staphylococcus aureus, Staphylococcus epidermidis, Staphylococcus saprophyticus, Staphylococcus spp., Streptococcus spp., vancomycin-resistant Enterococci (VRE), Vibrio cholerae, Vibrio hemolyticus, Vibrio spp., Yersinia enterocolitica, Yersinia pestis, Yersinia pseudotuberculosis, Burkholderia glumea, Pediococcus acidilactici/parvulus, Sphingomonas terrae , Corynebacterium spp., Gordonia rubripertincta, Rhodococcus rhodnii, Brevundimonas vesicularis, Providencian heimbachae, Gordonia sputi, Cellulosimicrobium cellulans, Sphingomonas sanguinis, Hydrogenophaga pseudoflava, Actinomadura cremea, and Xanthomonas spp.

In some implementations, the antimicrobial composition prevents growth and reproduction of fungi, yeasts, molds, and microorganisms selected from the group consisting of Candida albicans, Candida auris, Candida parapsilosis, Candida tropicalis, Candida glabrata, Candida krusei, Epidermophyton spp., Trichophyton spp., Kluyveromyces marxianus, Hyphopichia burtanii, Fusarium oxysporum, Botrytis cinerea, Aspergillus niger, Aspergillus spp., Alternaria alternata, Sclerotinia sclerotiorum, Paecilomyces lilacinus, Penicillium vinaceum, Penicillium expansum, Penicillium charlesii, and Penicillium expansum.

In some implementations, the antimicrobial composition reduces contamination of fomites by viral pathogens selected from the group consisting of Swine influenza (H1N1), H3N2, H2N2, Avian influenza A (H5N1), Avian influenza A (H9N2), Equine influenza (H3N8), Influenza B, Human coronaviruses, Feline infectious peritonitis virus (FIPV), Feline calicivirus F-9, Hepatitis A virus, Hepatitis B virus, SARS (Severe Acute Respiratory Syndrome) coronavirus, HIV-1, Respiratory syncytial virus, Coliphage MS2, Poliovirus, Rotavirus, Adenovirus, Murine norovirus, Lactobacillus case phage PL-1, and Human norovirus (calicivirus).

In a second general aspect, a material including the antimicrobial composition of the first general aspect is in the form of a liquid, a semi-liquid, a paste, a semi-solid, a solid, powder, granules, beads, pellets, rods, plates, tiles, films, coatings, fibers, hollow fibers, wires, strings, tubing, foams, or monoliths.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flowchart showing a process for forming geopolymeric aluminosilicate particles.

FIGS. 2A and 2B depict a flow system and zero-length column chamber used for measurements described in the Examples.

FIG. 3A is an image of agar diffusion assays showing ion diffusion and MRSA inhibition of the silver-containing geopolymeric aluminosilicate sample (designated as “silver-nZeo” or “Ag⁺-nZeo”) which was produced by using the geopolymeric aluminosilicate sample (designated as “nZeo”) in Examples. FIG. 3B shows the inhibition diameter measurements from independent experiments.

FIG. 4 shows MRSA USA300 survival in nZeo and silver-nZeo (Ag⁺-nZeo) aqueous suspensions.

FIGS. 5A and 5B show MRSA USA300 survival in hours and minutes, respectively, upon exposure to small quantities of silver-nZeo (Ag⁺-nZeo).

FIG. 6 shows determination of the silver-nZeo (Ag⁺-nZeo) minimum bactericidal concentration (MBC) against MRSA USA300.

FIG. 7 shows silver release kinetics in a flow experiment at two different flow rates for silver-nZeo as well as for the silver-containing micron-sized aluminosilicate sample (designated as “silver-mZeo” or “Ag⁺-mZeo”) as a control which was produced by using the micron-sized NaX aluminosilicate sample (NaX from Sigma Aldrich; silver content after ion exchange: 25 wt %; designated as “mZeo”).

FIG. 8 shows correlation between the silver ion release kinetics and the antibacterial performance of silver-nZeo and silver-mZeo

FIG. 9 shows MRSA USA300 survival in aqueous suspensions of nZeo and copper-containing geopolymeric aluminosilicate sample (designated as “copper-nZeo” or “Cu²⁺-nZeo”).

FIG. 10 shows determination of the copper-nZeo (Cu²⁺-nZeo) MBC against MRSA USA300.

### DETAILED DESCRIPTION

The antimicrobial composition described herein includes an antimicrobial geopolymer. The antimicrobial geopolymer includes porous aggregates, such as those described in WO 2015/191817, entitled “GEOPOLYMER AGGREGATES,” which is incorporated herein by reference. The porous aggregates include aluminosilicate nanoparticles containing at least one of alkaline earth metals, rare earth metals, Mn, Fe, Co, Ni, Ag, Cu, Zn, Hg, Sn, Pb, Bi, Cd, Cr, and Tl in metallic form, ionic form, or a combination thereof

Geopolymers are commonly referred to by a variety of terms, including low-temperature aluminosilicate glass, alkali-activated cement, geocement, alkali-bonded ceramic, inorganic polymer concrete, and hydroceramic. Despite this variety of nomenclature, these terms all describe materials synthesized utilizing the same chemistry, which can be described as a complex system of coupled alkali-mediated dissolution and precipitation reactions of aluminosilicates in an aqueous reaction substrate. Geopolymers are nanomaterials that exhibit a dense gel-like structure with 5 nm to 60 nm-sized amorphous aluminosilicate particles. Their chemical structure generally includes an amorphous, three-dimensional network of corner-sharing aluminate and silicate tetrahedra, with the negative charge due to Al^{3 +} ions in the tetrahedral sites typically balanced by the alkali metal ions. Alkali-activated aluminosilicates are a type of geopolymer. Geopolymers can be prepared typically by curing geopolymer resins. In some cases, geopolymer resins are prepared by coupled alkali-mediated dissolution and precipitation reactions of silicate or aluminosilicate precursors in an aqueous media. The term “geopolymerization process” used herein includes chemical processes that provide a geopolymer. As used herein, “geopolymer resin” includes uncured or partially cured alkali-activated aluminosilicates from the geopolymerization process.

Aggregates referred to herein follow the IUPAC recommendation in Pure and Applied Chemistry 79, 1801-1829 (2007), which is incorporated by reference herein. That is, “aggregates” refer to clusters of “primary particles” (also referred to as “elementary particles”) interconnected by chemical bonds, and do not typically break down or disintegrate typically by a mechanical treatment. Aggregates may also be referred to as “secondary particles.”

Pores defined by the porous geopolymer materials can include micropores (i.e., pores with a pore size less than about 2 nm), mesopores (i.e., pores with a pore size between about 2 nm and about 50 nm), macropores (i.e., pores with a pore size greater than about 50 nm), or any combination thereof. In some cases, pores defined by the porous materials include a majority or a significant majority of mesopores or open mesopores. As used herein, “majority” refers to greater than 50% (e.g., greater than 60%, 70%, 80%, 90%, 95%, or 99%) and “significant majority” refers to greater than 75% (e.g., greater than 80%, 90%, 95%, or 99%). In some cases, pores defined by the porous materials include a majority or a significant majority of macropores or open macropores. In certain cases, pores defined by the porous materials include mesopores and macropores. In this disclosure, the terms “pore width,” “pore size,” and “pore diameter,” are used interchangeably.

Zeolites are typically described as crystalline aluminosilicates having ordered channel and/or cage structures and containing micropores (“zeolitic micropores”) whose pore windows are typically smaller than about 0.9 nm. The network structure of such zeolites consists of SiO₄ and AlO₄ tetrahedra that share oxygen bridges.

Geopolymer materials are typically produced into a hard monolithic form by curing a geopolymer resin. In some cases, geopolymer materials are obtained as particulates. For example, WO 2013/044016, entitled “GEOPOLYMER RESIN MATERIALS,” which is incorporated herein by reference, describes forming geopolymer particulates by contacting a geopolymer resin or geopolymer with a fluid and removing at least some of the fluid. The resulting particulates have one or more external dimensions ranging in size from about 0.1 μm to about 100 μm, from about 100 μm to about 5000 μm, or from about 5 mm to about 2 cm. As used herein, “about” refers to ±10% (e.g., about 100° C. refers to a range of temperatures between 90° C. and 110° C.) The aluminosilicate particulates produced by the processes may exhibit a nanoporous structure with a majority of pores having a pore width between 2 nm and 100 nm among the pores when their pore volume contribution and their distribution are estimated with Brunauer-Emmett-Teller (BJH) analysis of the desorption branch of the N₂ gas sorption isotherm. In some cases, a majority of the pores are mesopores. The total specific surface area of the geopolymeric aluminosilicates may be from about 10 m²/g to about 900 m²/g based on the Brunauer-Emmett-Teller (BET) analysis of the N₂ sorption isotherm. The specific micropore surface area of the geopolymeric aluminosilicates may be from about 0 m²/g to about 700 m²/g based on the t-plot analysis. In some cases, the specific external surface area of the geopolymeric aluminosilicates is estimated to be about 10 to about 300 m²/g by subtracting the specific micropore surface area from the total specific surface area (BET surface area).

The zeolitic crystallinity of geopolymeric aluminosilicates may be controlled during synthesis. Such control may include, for example, use of a variety of reagents, including organic template molecules such as quaternary ammonium ions. Aluminosilicate geopolymer materials are resistant to acids, which may allow a more flexible condition for modification of materials, especially materials that include an acidic component. The aluminosilicate geopolymer materials are generally stable in water and do not undergo gelation over time, thus allowing flexibility with respect to material handling and transfer. Accordingly, geopolymeric aluminosilicates are suitable for applications such as fillers, pigments and reinforcing fillers for rubber compounds, plastics, paper and paper coating compositions, paints, adhesives, and the like. Such fillers typically have an external dimension no larger than 1 μm and exhibit a relatively high surface area.

As described herein, aluminosilicate nanoparticles (“primary particles”) may remain aggregated while they are forming to yield porous aggregates (“secondary particles”). An average primary particle size of the aluminosilicate nanoparticles is between about 5 nm and about 60 nm, and a majority of the porous aggregates have a particle size between about 50 nm and about 1 μm. In some cases, the aluminosilicate primary particles are porous. In certain cases, a majority of the pores between the aluminosilicate primary particles in the porous aggregates have a pore width between about 2 nm and about 100 nm. In some cases, the porous aggregates are formed during formation of the primary particles. In certain cases, the aluminosilicate nanoparticles of each porous aggregate are interconnected through chemical bonds throughout the formation of the porous aggregate.

The average particle size of the primary particles can be estimated by using various characterization methods including transmission electron microscopy and gas sorption studies. The average particle size of the secondary particles can be estimated by using various characterization methods including scanning electron microscopy and dynamic light scattering. The dynamic light scattering methods provide the particle size as a hydrodynamic particle diameter and are applicable to particles in a dispersion. Various methods are available in calculating the average particle sizes from dynamic light scattering experiments. Z-average, Z-average size, or Z-average mean used in dynamic light scattering is a parameter also known as the cumulants mean. The Z-average mean is often used in a quality control setting as it is defined in ISO 13321 and ISO 22412, which are incorporated herein by reference.

In some cases, the mesopore volume (i.e., the total pore volume from the pores having a pore width between 2 nm and 50 nm) of the aggregates is at least about 0.05 cc/g, at least about 0.1 cc/g, at least about 0.2 cc/g, or at least about 0.3 cc/g on the BJH cumulative pore volume from the desorption branch of the N₂ sorption isotherm. In some cases, the mesopore volume of the aggregates contributes at least about 60%, at least about 70%, or at least about 80% of the total pore volume of the aggregates from the pores having a pore width from 2 to 100 nm based on the BJH cumulative pore volume from the desorption branch of the N₂ sorption isotherm. In some cases, the specific external surface area (i.e., total specific surface area minus specific micropore surface area) of the aggregates is at least about 10 m²/g and no greater than about 300 m²/g. In certain cases, the specific micropore surface area of the aggregates is at least about 100 m²/g and no greater than about 700 m²/g, and the aluminosilicate has zeolitic micropores.

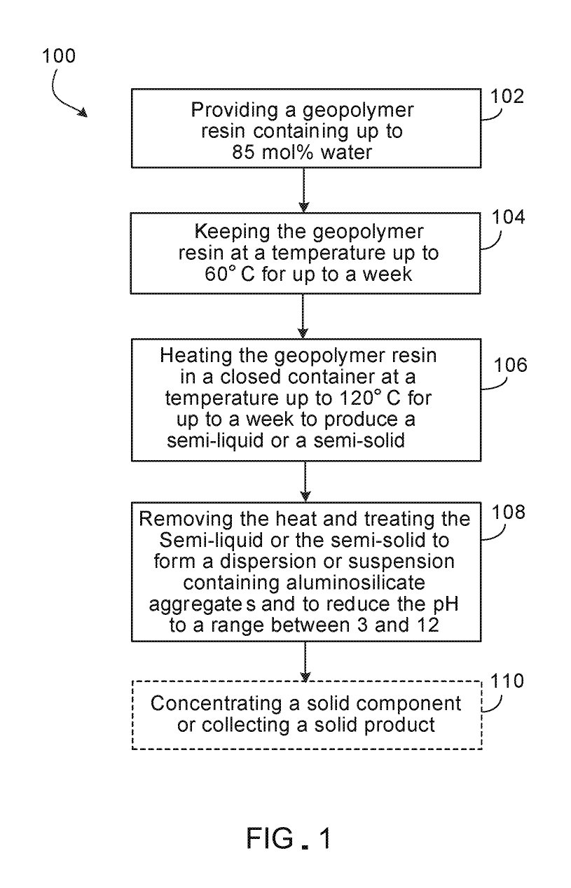

As depicted in the flowchart in FIG. 1, a process (100) for forming porous aluminosilicate aggregates from a geopolymer resin includes (102) providing a geopolymer resin containing up to about 85 mol % water; (104) optionally keeping the geopolymer resin at a temperature up to about 60° C. for up to a week; (106) heating the geopolymer resin in a closed container at a temperature up to about 120° C. for up to a week to produce a semi-liquid or a semi-solid; (108) removing the heat and treating the semi-liquid or the semi-solid to form a dispersion or suspension containing porous aluminosilicate aggregates and to reduce the pH to a range between 3 and 12; and (110) optionally concentrating a solid component or collecting a solid product including the porous aluminosilicate aggregates.

As used herein, a “semi-liquid” is defined as a fluid having a thick consistency between that of a solid and a liquid, and a “semi-solid” is defined as a wet or partially wet solid that can be disintegrated or dispersed when it is contacted with a liquid. The semi-liquid or semi-solid may be formed by partially curing a geopolymer resin. Partial curing of a geopolymer resin can occur with short curing times (several hours or a day, for example) or low curing temperatures (at room temperature, for example). In some cases, partial curing occurs when a large amount of water or alkali is present in a geopolymer resin or when an organic component is present in the geopolymer resin. The organic component may include one or more of esters, organic carboxylates, and organic carboxylic acids. Elevated temperatures typically accelerate curing. In some cases, the temperature is varied during curing. In certain cases, a geopolymer resin is kept at a certain temperature (room temperature, for example) for a length of time (i.e., “aged”) before curing or partially curing. In some cases, a geopolymer resin is aged after curing or after partially curing.

The semi-liquid or the semi-solid may be in the form of a cake, a paste, or a slurry. Forming the dispersion or suspension from the semi-liquid or semi-solid may include, for example, a mechanical treatment such as shaking, shearing, homogenizing, agitating, stirring, ultrasonication, or a combination thereof. A dispersant or dispersion stabilizer may be added to facilitate the mechanical treatment. In some cases, reducing the pH may be carried out by repetitive water exchange, adding an acid, ion exchange, or a combination thereof.

The dispersion or suspension may be treated chemically. In some cases, the dispersion or suspension includes an organic, inorganic, or biological component which can modify the aggregates in the dispersion or suspension. Such modification may include, for example, impregnation of the organic, inorganic or biological component into the aggregates; deposition or coating of the organic, inorganic, or biological component onto the internal and/or external surface of the aggregates; and the like. The impregnation, deposition, or coating may be induced by electrostatic attraction or covalent crosslinking between the surface moieties of the aggregates and the organic, inorganic or biological component. In some cases, the modification includes ion exchange; that is, the alkali ions in the aluminosilicates are exchanged partially or completely by other cations, metal ions or protons present in the dispersion or suspension. Treatment of the aggregates may make the aggregates hydrophobic, change the point of zero charge (PZC) or the zeta potential of the aggregates, alter the optical properties of the aggregates, alter the surface properties, provide cross-linking moieties on the surface, impart antimicrobial properties to the aggregates, or a combination thereof. The surface charge of particles in water correlates to the stability of their aqueous dispersion. When the absolute value of a measured zeta potential is in the range of 0 mV to 5 mV, there can be rapid coagulation/agglomeration among the particles; 10 mV to 30 mV may represent an incipient instability of the dispersion; 30 mV to 40 mV may represent a moderate stability; 40 mV to 60 mV may represent a good stability; and ≥60 mV may signify an excellent stability.

Concentrating the solid component may be carried out by filtration, water evaporation or centrifugation. Concentrating the solid component may be helped by adding a flocculant, a coagulant, or a surfactant. Collecting the solid product may be carried out by filtration, rinsing, and subsequent drying to yield aluminosilicate aggregates in the form of a powder or granules. Drying may include, for example, ambient drying, spay drying, drying by heating, freeze drying, or a combination thereof. In some cases, freeze drying can lead to a lesser degree of agglomeration in the dried product than ambient drying and drying by heating. The solid product may be further ground, milled, or pulverized.

The resulting aluminosilicate aggregates may have zeolitic micropores. In some cases, the aluminosilicate aggregates may have zeolitic micropores exhibiting a sodalite (SOD), faujasite (FAU), EMC-2 (EMT), or zeolite A (LTA) type structure.

Modification of the aluminosilicate aggregates may result in a significant portion of the pore surface of the aluminosilicate aggregates being covered or coated with organic molecules, surfactants, polymers, inorganic molecules, nanoparticles, or a combination thereof.

In certain cases, modification results in a significant portion of the pores of the aluminosilicate aggregates being impregnated with nanoparticles or with molecules of a biological origin. In some cases, modification of the aluminosilicate aggregates results in exchange of a significant portion of the alkali ions in the aluminosilicate aggregates with other metal ions or protons.

In some cases, the aluminosilicate aggregates or the modified aluminosilicate aggregates absorb water, moisture, oil, organic molecules, or a combination thereof. The aluminosilicate aggregates or the modified aluminosilicate aggregates may neutralize or scavenge an acid, retard fire propagation, or release metal ions or metal nanoparticles that have an antibacterial effect. The aluminosilicate aggregates or the modified aluminosilicate aggregates may act as a colorant or a sun-block agent. The modified aluminosilicate aggregates may absorb a light in the visible light range (from about 390 nm to about 700 nm).

The aluminosilicate aggregates or the modified aluminosilicate aggregates may be mixed with a material to form a mixture. The material may partially or completely fill pores in the aluminosilicate aggregates. In some cases, the material is, for example, water, an aqueous solution, an organic solvent, an organic solution, an organic polymer, an organic polymer melt, or a combination thereof. In certain cases, the material is or includes cellulose, paint, adhesives, paper, cosmetics, medicines, or natural or synthetic rubber (e.g., for use in tires). The incorporation of the aluminosilicate aggregates or the modified aluminosilicate aggregates in rubber compositions used for the manufacture of tires and tire components may result in a reduction in the rolling resistance, an improvement in adhesion to wet, snow-covered or icy ground, an increase in wear resistance, a reduction of curing time of the rubber compositions, or a combination thereof.

The aluminosilicate aggregates or the modified aluminosilicate aggregates may enhance or retard the polymerization or cross-linking of the organic component in the mixture. In some cases, the mixing is designed in such a way that the solid product disagglomerates sufficiently. The mixing may be helped by shaking, shearing, homogenizing, agitating, stirring, sonicating, vibrating, crushing, pounding, grinding, pulverizing, milling, crumbling, smashing, mashing, pressing, or triturating.

The mixing may be carried out in combination with addition of an additive. The additive may serve as a cross-linker between the aluminosilicate and an organic polymer or an elastomer. In some cases, the mixture includes an inorganic component. In certain cases, the mixture is biological in origin. In one example, the mixture is a fertilizer. In other examples, the mixture is a pesticide, a fungicide, an herbicide, an antimicrobial, or the like. In still other examples, the mixture is a polymer foam or porous material including a polymer. The aluminosilicate aggregates or the modified aluminosilicate aggregates in the mixture may reduce the thermal conductivity of the polymeric foam or porous material.

An average particle size of the aluminosilicate nanoparticles in the antimicrobial geopolymer may be between about 5 nm and about 100 nm. A majority of the pores between the aluminosilicate nanoparticles in the porous aggregates may have a pore width between about 2 nm and about 100 nm. A majority of the porous aggregates typically have a particle size between about 50 nm and about 10 μm or between about 50 nm and about 1 μm.

In some cases, the mesopore volume of the porous aggregates is at least about 0.05 cc/g, at least about 0.1 cc/g, at least about 0.2 cc/g, or at least about 0.3 cc/g on the BJH cumulative pore volume from the desorption branch of the N₂ sorption isotherm, wherein the mesopore volume is the total pore volume of the pores having a pore width from about 2 to about 100 nm. The mesopore volume of the porous aggregates may contribute at least about 10%, at least about 30%, at least about 50%, at least about 70%, or at least about 90% of the total pore volume of the aggregates from the pores having a pore width between about 2 nm and about 100 nm based on the BJH cumulative pore volume from the desorption branch of the N₂ sorption isotherm. In certain cases, the specific external surface area of the porous aggregates is between about 10 m²/g and about 300 m²/g, wherein the specific external surface area of the porous aggregates is the total specific surface area minus the specific micropore surface area. The specific micropore surface area of the porous aggregates may be between about 100 m²/g and about 700 m²/g, and the aluminosilicate may have zeolitic micropores.

The porous aggregates may be formed during formation of the aluminosilicate nanoparticles, and the aluminosilicate nanoparticles of each of the porous aggregates may be interconnected through chemical bonds throughout the formation of the porous aggregates. In some cases, the porous aggregates are formed in a geopolymerization process. In certain cases, the porous aggregates are formed by a process including providing a geopolymer resin containing up to about 85 mol % water; optionally keeping the geopolymer resin at a temperature up to about 60° C. for up to about a week; optionally heating the geopolymer resin in a closed container at a temperature up to about 120° C. for up to about a week to yield a semi-liquid or a semi-solid; treating the semi-liquid or the semi-solid to form a dispersion or suspension comprising the porous aggregates and reducing the pH of the dispersion or suspension to a range from about 3 to about 12; and optionally concentrating a solid component or collecting a solid product from the dispersion or suspension.

The aluminosilicate nanoparticles may have zeolitic micropores, such as zeolitic micropores with a FAU, EMT or LTA structure. Some or all of the ion-exchangeable ions in the aluminosilicate nanoparticles may be replaced with one or more of: alkaline earth metals, rare earth metals, Mn, Fe, Co, Ni, Ag, Cu, Zn, Hg, Sn, Pb, Bi, Cd, Cr, and Tl. In one example, the aluminosilicate nanoparticles contain about 0.1 wt % to about 30 wt % of one or more metal ions, after the ion exchange, selected from the group consisting of Ag, Cu and Zn ions.

In an antimicrobial geopolymer, silver-containing porous aggregates may release at least 33% of silver within about 30 minutes when the porous aggregates are in contact with 0.9 wt % NaNO₃ solution flowing at 1.2 mL/min. The silver-containing porous aggregates may release at least 33% of silver within about 10 minutes when the porous aggregates are in contact with 0.9 wt % NaNO₃ solution flowing at 5.0 mL/min.

The silver-containing porous aggregates may show minimum bactericidal concentration (MBC) values equivalent to no greater than about 1 μg of Ag per mL for methicillin-resistant Staphylococcus aureus (MRSA) within about 2 hours. In other implementations, the silver-containing porous aggregates may show MBC values equivalent to no greater than about 1 μg of Ag per mL MRSA within about 24 hours. In other implementations, the silver-containing porous aggregates may show MBC values equivalent to no greater than about 10 μg of Ag per mL MRSA within about 24 hours.

The silver-containing porous aggregates may show minimum inhibitory concentration (MIC) values equivalent to no greater than about 2 μg of Ag per mL for methicillin-resistant Staphylococcus aureus (MRSA) within about 2 hours. In other implementations, the silver-containing porous aggregates may show MIC values equivalent to no greater than about 1 μg of Ag per mL MRSA within about 24 hours. In other implementations, the silver-containing porous aggregates may show MIC values equivalent to no greater than about 10 μg of Ag per mL MRSA within about 24 hours.

The copper-containing porous aggregates may show minimum bactericidal concentration (MBC) values equivalent to no greater than about 100 μg of Cu per mL for methicillin-resistant Staphylococcus aureus (MRSA) within about 2 hours. In other implementations, the copper-containing porous aggregates may show MBC values equivalent to no greater than about 2000 μg of Cu per mL MRSA within about 24 hours.

In some cases, the porous aggregates are modified so that the pore surface of the porous aggregates is covered or impregnated partially or completely with antimicrobial molecules, surfactants, metals, metal ions, inorganic compounds, or polymers or a combination thereof. In some cases, the porous aggregates are modified so that the pore surface of the porous aggregates is covered partially or completely with antimicrobial molecules or nanoparticles. In some cases, the porous aggregates are modified so that the pores of the porous aggregates are impregnated partially or completely with antimicrobial nanoparticles.

The antimicrobial composition typically includes about 0.05 wt % to about 99 wt % of the porous aggregates. The antimicrobial composition is understood to prevent microbial contamination for an extended duration by loading metal ions or metals on the porous aggregates, and to be durable against biological deterioration, light exposure, corrosion, decay, or a combination thereof. In some examples, the antimicrobial composition prevents growth and reproduction of bacteria including Acinetobacter lwoffii, Acinetobacter calcoaceticus, Acinetobacter baumannii, Acinetobacter spp., Aeromonas spp., Alcaligenes spp., Achromobacter spp., Bacillus anthracis, Bacillus cereus, Bacillus coagulans, Bacillus megaterium, Bacillus subtilis, Bacteriodes fragilis, Brevundimonas spp., Campylobacter jejuni, carbapenem-resistant Enterobacteriaceae, Citrobacter spp., Clostridium perfringens, Enterococcus faecium, Enterococcus faecalis, Escherichia coli including EHEC, EPEC, ETEC, EIEC, and EAEC, Klebsiella pneumoniae, Listeria monocytogenes, methicillin-resistant Staphylococcus aureus (MRSA), Micrococcus luteus, Mycobacterium abscessus, Mycobacterium avium, Mycobacterium chelonae, Mycobacterium fortuitum, Mycobacterium marinum, Mycobacterium scrofulaceum, Mycobacterium ulcerans, Proteus mirabilis, Proteus vulgaris, Pseudoxanthomonas spp., Pseudomonas putida, Pseudomonas aeruginosa, Pseudomonas maculicola, P seudomanas chlororaphis, Pseudomonas flourescens, Pseudomonas tolaasii, Pseudomonas spp., Propionibacterium acnes, Nocardia brasiliensis, Nocardia asteroides, Nocardia globerula, Nocardia transvalensis, Nocardia spp., Stenotrophomonas maltophilia, Pantoea stewartii subspecies stewartii, Chryseobacterium balustinus, Duganella zoogloeoides, Chryseobacterium meningosepticum, Salmonella spp., Shigella spp. Staphylococcus aureus, Staphylococcus epidermidis, Staphylococcus saprophyticus, Staphylococcus spp., Streptococcus spp., vancomycin-resistant Enterococci (VRE), Vibrio cholerae, Vibrio hemolyticus, Vibrio spp., Yersinia enterocolitica, Yersinia pestis, Yersinia pseudotuberculosis, Burkolderia glumea, Pediococcus acidilactici/parvulus, Sphingomonas terrae, Corynebacterium spp., Gordonia rubripertincta, Rhodococcus rhodnii, Brevundimonas vesicularis, Providencian heimbachae, Gordonia sputi , Cellulosimicrobium cellulans, Sphingomonas sanguinis, Hydrogenophaga pseudoflava, Actinomadura cremea, and Xanthomonas spp. In other examples, the antimicrobial composition prevents growth and reproduction of bacteria that are antibiotic-resistant. In other examples, the antimicrobial composition prevents growth and reproduction of fungi, yeasts, molds, and other microorganisms including Candida albicans, Candida auris, Candida parapsilosis, Candida tropicalis, Candida glabrata, Candida krusei, Epidermophyton spp., Trichophyton spp., Kluyveromyces marxianus, Hyphopichia burtanii, Fusarium oxysporum, Botrytis cinerea, Aspergillus niger, Aspergillus spp., Alternaria alternata, Sclerotinia sclerotiorum, Paecilomyces lilacinus, Penicillium vinaceum, Penicillium expansum, Penicillium charlesii, and Penicillium expansum. In other examples, the antimicrobial composition reduces contamination of fomites by viral pathogens including Swine influenza (H1N1), H3N2, H2N2, Avian influenza A (H5N1), Avian influenza A (H9N2), Equine influenza (H3N8), Influenza B, Human coronaviruses, Feline infectious peritonitis virus (FIPV), Feline calicivirus F-9, Hepatitis A virus, Hepatitis B virus, SARS (Severe Acute Respiratory Syndrome) coronavirus, HIV-1, Respiratory syncytial virus, Coliphage MS2, Poliovirus, Rotavirus, Adenovirus, Murine norovirus, Lactobacillus case phage PL-1, and Human norovirus (calicivirus).

The antimicrobial composition demonstrates antimicrobial properties in compositions or materials such as dispersions, suspensions, gels, greases, creams, lotions, ointments, cosmetics, toothpastes, mouth washes, soaps, detergents, disinfectants, antiseptics, hygiene products, gauzes, bandages, sponges, adhesives, sealants, grouts, glazes, paints, coatings, paper, cement, ceramics, glasses, plaster, thermal insulating materials, sound proofing materials, tiles, rubber, silicone rubber, plastics, fabrics, or cat litter. In some cases, the antimicrobial composition is applied by addition to raw materials of technological products and paints or coatings, especially in household appliances; electronic devices, displays and touch screens; phones, smartphones, recording devices, microphones, listening devices, earphones and headphones; fabrics, cloths, uniforms, outerwear, gloves, aprons, coats, wipes, masks, shoes and garments; personal protective equipment including cloths, gloves, helmets, goggles, facemasks and respirators; medical supplies, implantable devices, medical device connectors and adaptors, medical monitoring devices, medical tubing, drug delivery devices, reusable medical devices and wound care devices; catheters, gastronomy tubes and stethoscope diaphragms; hygiene products including cleansing pad, cotton pad, cotton swab, deodorant, antiperspirant, disposable towel, facial tissue, handkerchief, menstrual cup, menstrual pad, pantiliners, paper towel, sanitary napkin, shave brush, shaving cream, shower gel, tampon, underarm liners, washing mitt and wet wipe; paper products including wall coverings, towels, wipes, napkins and book covers; packaging items including bags, sacks, wraps, cushion, absorbent materials, and containers; water filter components and housing units, water bottle dispensers and components, water dispensers, ice machine trays, ice machine bins, ice machine water hoses, ice dispensers, water bottles, water cups and water storage vessels; food processing or storage equipment and utensils including slicers, formers, juicers, washers, canners, freezers, refrigerators, shelving, cookers, grinders, choppers, peelers, compactors, homogenizers, mills, presses, processor tanks, heat exchangers, filters, screens, centrifuges, clarifiers, dryers, reactors, evaporators, spray dryers, freeze dryers, fillers, sealers, openers, seamers, wrappers, cutting boards, counter tops, dishes, forks, knives, cups, bottles, conveyor belts, conveyors, cutlery, food containers and food wraps; beverage processing equipment including mixers, transfer equipment, pumps, bottlers, canners, dispensers and fermenters; heating, ventilation and air conditioning equipment including insulation, ducts, heat exchangers and drain pans; air filters, air purifiers and diffusers; insulation for wire and cable; drainage and sewage pipes; furniture, houses and buildings; walls, wallboard, floors, flooring, mats, stucco, plaster, floor coverings, concrete, siding and roofing; automotive and vehicular parts; bathroom hardware and supplies including spas, bathtubs, showers and shower curtains; footwear including boots; sports equipment and tools; personal care items including grooming items, and sports and dental mouth guards; cleaning/storage supplies including waste containers, brush handles, mops, vacuum cleaner bags, garbage bags and garbage cans; brush bristles and cosmetic brushes; air conditioners, refrigerators, washing machines, dishwashers, microwave ovens, television, printer, computer and computer hardware; gauze and bandages; and filter components of air purifiers, water purifiers, and humidifiers. Materials including the antimicrobial composition may be in the form of a liquid, a semi-liquid, a paste, a semi-solid, a solid, powder, granules, beads, pellets, rods, plates, tiles, films, coatings, fibers, hollow fibers, wires, strings, tubing, foams, or monoliths.

The following examples are provided for illustration. It should be appreciated by those of skill in the art that the techniques disclosed in the following examples are considered to be exemplary. However, those of skill in the art should, in light of the present disclosure, appreciate that many changes can be made in the specific embodiments that are disclosed without departing from the spirit and scope of this disclosure.

### EXAMPLES

Synthesis of Geopolymer Aluminosilicate Samples (nZeos)

nZeos were synthesized by first preparing a geopolymer resin with the composition of 3.0Na₂O : 1.0Al₂O₃: 4.0SiO₂: 32.4H₂O. The geopolymer resin was prepared by first dissolving 4.555 g of NaOH pellets (Sigma Aldrich) and 11.711 g of water glass (Sigma Aldrich) in deionized (DI) water (8.190 g), and then 5.735 g of metakaolin (MetaMax® from BASF) was added to the solution. After stirring with a mechanical mixer (IKA® RW 60 digital mixer) at 800 rpm for 40 min, a visually homogeneous and free-flowing geopolymer resin was obtained. Into the resin, 15 mL of canola oil (J. M. Smucker Company, Crisco®) was added and stirred for another 10 min. The resin-oil mixture was then poured into 50 mL polypropylene tubes, closed tightly, and placed in a laboratory oven at 60° C. for 54 hours. After heating, the product, exhibiting a consistency of paste, was taken out from the tubes and washed with hot deionized water (90° C.) multiples times. The final product was collected after vacuum filtration with cold deionized water until the pH of the filtrate was about 8. The product was then dried in a laboratory oven at 110° C. overnight and stored in sealed glass vials at room temperature for further use.

### Preparation of Metal-nZeos

Silver-nZeo: All the handling of silver-containing materials was carried out in a darkroom. 1.000 g of nZeo was suspended in 150 mL of nanopure water in a 500 mL beaker, and the pH of the suspension was adjusted to about 5 by slowing addition of 0.01 M nitric acid. 0.059 M silver nitrate solution was prepared by dissolving 1.000 g of AgNO₃ (Sigma-Aldrich, 99.9%) into 100 mL nanopure water and the pH was adjusted to around 5 by adding the nitric acid. The silver nitrate solution was poured into the nZeo suspension and the mixture suspension was stirred gently for 24 hrs with a magnetic stirrer. The particles were collected by filtration, rinsed with nanopure water, and dried at 90° C. overnight. The amount of silver was estimated to be 24 wt % based on PIXE (proton induced X-ray emission) and RBS (Rutherford backscattering) analysis and the Si/Al ratio from the unit cell refinement of the powder X-ray diffraction (PXRD) pattern.

Copper-nZeo: 1.0 g of nZeo was suspended in 150 mL of nanopure water in a 400 mL beaker, and the pH of the suspension was adjusted to about 5 by slowing addition of 0.01 M nitric acid. 0.05 M copper nitrate solution was prepared by dissolving 1.0 g of Cu(NO₃)₂ (Sigma-Aldrich, 99.9%) into 150 mL nanopure water and the pH was adjusted to around 5 by adding nitric acid. The copper nitrate solution was poured into the nZeo suspension and the mixture suspension was stirred gently for 24 hrs with a magnetic stirrer. The particles were collected by filtration, rinsed with nanopure water and dried at 90° C. overnight. The amount of copper was estimated to be 7 wt % based on PIXE and RBS analysis and the Si/A1 ratio from the unit cell refinement of the PXRD pattern.

Sterilization: All nZeos, silver-nZeos and copper-nZeos were sterilized with 180-200° C. dry heat for 2 hours. Bacterial spore strips were also concurrently exposed to 180-200° C. dry heat for 2 hours. Lack of subsequent growth confirmed sterilization.

### Characterization

PXRD patterns of the dried samples were collected on a Bruker D8 specialized powder X-ray diffractometer (Ni-filtered Cu Kα radiation with a wavelength of 1.5406 Å, operated at 40 kV and 40 mA, VANTEC-1 position-sensitive detector) at a scan speed of 2.0 degrees/min and a step size of 0.016 degrees 2θ. The resolution of the VANTEC-1 position-sensitive detector was 2θ=0.008 degrees. Scherrer's equation was applied to [111], [133] and [246] diffraction peaks (20=˜6, ˜16 and ˜27°, respectively) associated with an FAU structure to estimate the average crystallite size.

Scanning Electron Microscopy (SEM) imaging of powdered samples was performed with a SEM-XL30 Environmental FEG (FEI) microscope. The analysis was performed with 15 kV acceleration voltage and a spot size of 3. For SEM, finely ground dried sample powders were sprinkled on to the SEM stub affixed with copper conducting tape and the samples were then gold coated for 75 s right before imaging. Transmission Electron Microscopy (TEM) imaging was performed on a JEOL TEM/STEM 2010F (Schottky Field Emission source, accelerating voltage 200 kV). For TEM studies, sample powders were first dried at 250° C. for at least 12 h under vacuum until a residual pressure of ≤10 μmHg was reached. The dried powders were then quickly sprinkled onto the copper grid covered with a holey carbon film right before sample loading.

Brunauer-Emmett-Teller (BET) surface areas were estimated with a Micrometrics ASAP 2020 volumetric adsorption analyzer with nitrogen as the adsorbate at 77 K. Prior to the analysis, samples (about 300 mg) were degassed at 250° C. for at least 12 h under vacuum until a residual pressure of ≤10 μmHg was reached. The specific surface area was calculated according to the BET equation, using nitrogen adsorption isotherms in the relative pressure range from 0.01 to 0.2. Specific surface area of micropores and the micropore volume were calculated by applying the t-plot method in the thickness range of 0.35 nm to 0.50 nm and the Harkins and Jura thickness equation. External surface area was estimated as the difference between specific surface areas obtained from BET equation and t-plot method. For the calculation of mesopore size distribution, desorption branch was considered and the total pore volume was obtained from the amount of nitrogen adsorbed at a relative pressure (P/Pₒ) of 0.99, assuming complete pore saturation. Mesopore size distributions were obtained using the Barrett-Joyner-Halenda (BJH) method assuming a cylindrical pore model. nZeos have a mesopore volume of 0.21 cm³/g and an external surface area of 97 m²/g. The micropore volume and surface area are 0.31 cm³/g and 663 m²/g, respectively, indicating about 100% crystallinity.

### Silver Release Kinetics

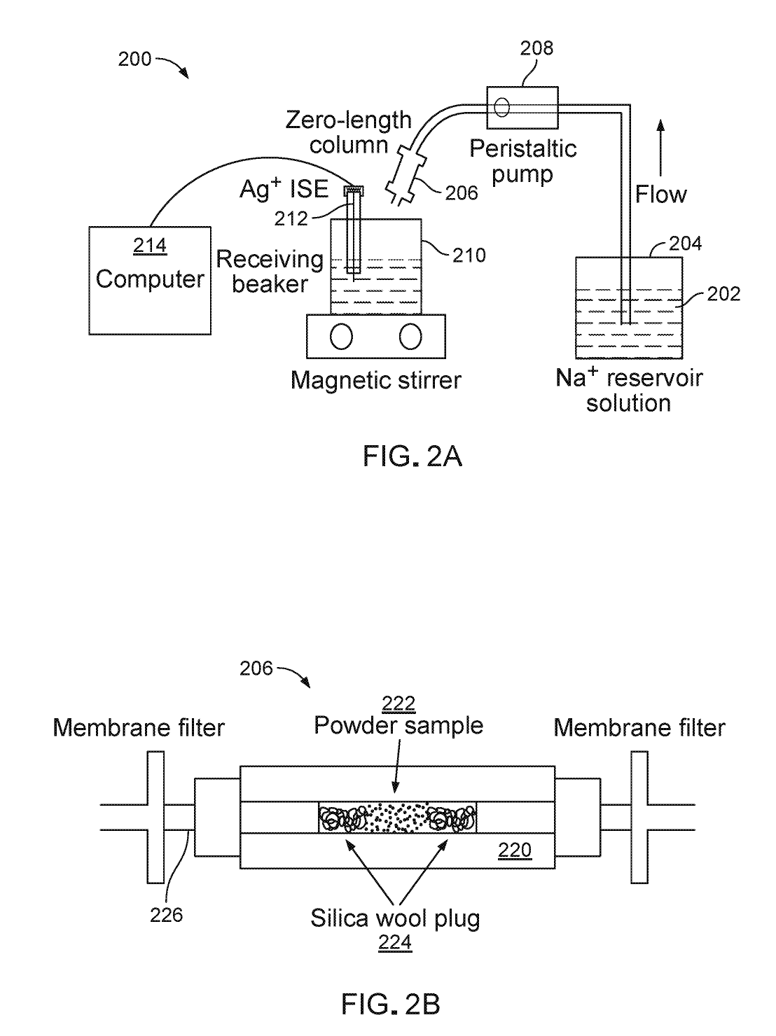

A continuous flow technique, similar to liquid-phase chromatography, was employed to investigate the silver release for silver-nZeo at a room temperature using a flow system such as flow system 200 depicted in FIG. 2A. During use, sodium ion solution 202 from reservoir 204 was passed through zero-length column 206 at a constant flow rate via peristaltic pump 208 and reached receiving beaker 210, where the released silver concentration was continuously measured with silver ion-selective electrode 212. Suitable peristaltic pumps include Masterflex L/S Pump Model No. 07554-80 with Pump Head No. 07518-00. FIG. 2B is an enlarged, cross-sectional view of zero-length column 206. Zero-length column 206 includes sample chamber 220. Powder sample 222 is loaded in a cavity of sample chamber 220 between silica wool plugs 224. Sample chamber 220 may be formed of polypropylene. In one example, sample chamber 220 has a diameter of 6.35 mm. Ends of sample chamber 220 may be fitted with membrane filters 226. In one example, the membrane filters are polytetrafluoroethylene (PTFE) filters having a diameter of 4 cm in diameter and a pore size of 0.45.

In one example, 0.1036 g of sample was loaded in sample chamber 220, and the ends of sample chamber 220 were plugged with silica wool 224. Both the influent and effluent were carried through 3.1 mm i.d. PTFE tubing connected to peristaltic pump 208. An unbuffered 0.9 wt % NaNO₃ solution was passed through the chamber at two different flow rates of 5.0 and 1.2 mL/min, and the silver ion concentration was measured continuously in the receiving beaker for various periods up to 70 min. The flow rate was monitored throughout and found to oscillate by <3.0%. The time-dependent release amount was calculated from the volume of the effluent and its concentration which was measured by using a silver ion-selective electrode. The monitoring time periods were limited by the volume of the receiving beaker and the minimum concentration limit of the silver ion-selective electrode.

### Bacterial Strains and Growth Conditions

MRSA USA300 was grown in trypticase soy broth (TSB) or on trypticase soy agar (TSA). Cultures were grown overnight for 17-19 h at 37° C. with gentle rotary mixing, and subsequently diluted 1:40 into fresh medium for growth to mid-logarithmic phase at 37° C. for 2.5 hours.

### Agar Diffusion Assays

Antibacterial activity of the silver-exchanged nZeo was determined by agar diffusion assays using 10 mg of silver-nZeo or nZeo and the following antibiotics: doxycycline (30 μg), tobramycin (10 μg), amoxicillin with clavulanic acid) (20/10 μg), trimethoprim/sulfamethoxazole (25 μg), and oxacillin (1 μg) (Becton Dickinson, N.J.). Wells (1 mm) were generated in TSA plates by removing agar bores with the end of sterile Pasteur pipette. Dry silver-nZeo or nZeo (10 mg) was subsequently funneled into each well by pouring through a sterile Pasteur pipette. The plates were incubated at 37° C. after MRSA inoculation onto the agar surface, addition of silver-nZeo or nZeo to the wells, addition of 5 μL of UV-irradiated, nanopure water (dH₂O) to respective wells, addition of 10 μL suspension of silver-nZeo or nZeo (10 mg) on the agar surface, and placement of control antibiotic disks. Zones of inhibition were measured after 20-24 h. Since the wells, surface suspensions, and antibiotic disks differed in diameter, four quadrant radius measurements were recorded and averaged for each zone of inhibition. To determine diameters of inhibition zones, radius measurements were doubled and disk width (6 mm) was added. All agar diffusion assays were performed at least three times. Prior to use, all nZeo materials were sterilized by 180° C. heating for 2 h.

Antibacterial Susceptibility Testing of nZeo and Metal-nZeos in Suspension

Exponential-phase MRSA cultures were prepared by diluting overnight cultures into fresh TSB and continuing growth at 37° C. with gentle rotary mixing until the cultures reached mid-logarithmic phase of growth (˜2.5 h). Cells were then diluted to a concentration of 10⁷ CFU/mL (OD₆₀₀=0.08−0.1). Prior to use, the cells were collected by centrifugation and resuspended with sterile dH₂O, followed by a second centrifugation and final resuspension in dH₂O. Cells were adjusted to a concentration of approximately 10⁷ CFU/mL. Sterilized nZeo or metal-nZeos were added to 1 mL of the initial bacterial suspension. Positive controls of bacterial growth without nZeo were included in each experiment. Cell viability was determined by plating in duplicate on TSA plates either directly from the experimental samples or following appropriate 10-fold dilutions at the specified times.

### Microdilution Antibacterial Susceptibility Testing

Exponential phase MRSA cultures were diluted to 10⁵ CFU/mL. Bacterial suspensions (100 μl) in cation-adjusted Mueller Hinton broth (CAMHB) were added to wells of 96-well microtiter plates containing Ag-nZeo, Ag-mZeo, or vancomycin ( 0.25 μg/m1). Minimum inhibitory concentration (MIC) was determined by measuring the absorbance at 600 nm after 24 h standing incubation at 37° C. Cell viability was determined by plating duplicate 10-fold serial dilutions for each sample onto Mueller Hinton agar plates and enumerating colonies after 16 h incubation at 37° C.

Antimicrobial Time-Kill Testing of MRSA with Metal-nZeos

MRSA USA300 cultures at mid-logarithmic phase were centrifuged, resuspended in 1.1% Na₂SO₄ (w/v), and diluted to 10⁷ CFU/mL. Bacterial suspensions were added to the wells of 96-well microtiter plates containing Ag-nZeo or nZeo. The microtiter plate was placed at 37° C. for the short duration of the experiment. Samples of the experimental wells were collected at 3, 7, and 10 min and subjected to 10-fold serial dilutions. At specified times, sodium thioglycolate ( 0.5% final concentration) was added to all experimental wells and included in serial dilutions to neutralize silver and prevent additional killing. Cell viability was determined by plating duplicate samples on TSA and enumerating colonies after 16 h incubation at 37° C. Statistical analyses

All biological experiments were performed in triplicate. Quantitative data were expressed as means±standard deviation (S.D.) or standard error of the mean (S.E.M.). Statistical analyses were performed using repeated measures of two-way or one-way analysis of variance (ANOVA) and Dunnett's or Tukey's multiple comparisons tests. For interpretation of biofilm data, nonparametric one-way ANOVA and Dunn's multiple comparisons test was used due to the high level of variability in biofilm generation. Statistical analyses were performed using GraphPad Prism 6 (GraphPad Software, San Diego, Calif.), and adjusted p values of <0.05 were considered statistically significant.

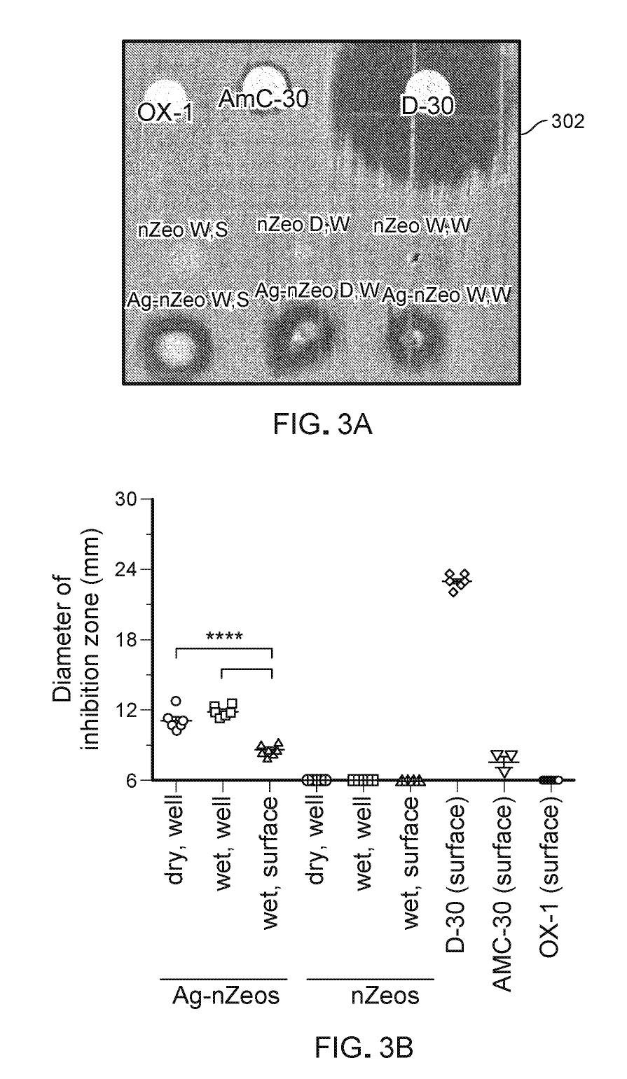

To assess MRSA inhibition and ion diffusion characteristics of the silver-nZeo particles, agar diffusion assays were performed. FIG. 3A shows silver diffusion and MRSA inhibition for examples in which silver-nZeo or nZeo were applied to the TSA plate in three different delivery configurations (W,S: wet, surface; W,W: wet, well; D,W: dry, well). For the two well configurations, wells (1 mm diameter) were generated in TSA plates by removing agar bores with the end of sterile Pasteur pipette. After MRSA inoculation onto the agar surface, dry silver-nZeo (10 mg) was subsequently funneled into each well or surface by pouring through a sterile Pasteur pipette. The wells were either left dry (D,W) or treated with addition of 5 μl of dH₂O (W,W). For the surface configuration, 10 μl suspension of silver-nZeo (10 mg) was gently dropped on the agar surface (W,S). After placement of control antibiotic disks, the plates were incubated at 37° C.

Radius measurements of the inhibition zones revealed silver diffusion distances of 11-12 mm for silver-nZeo particles embedded in agar wells. FIG. 3B shows diameter measurements of the inhibition zones collected from at least three independent experiments with doxycycline (D-30), trimethoprim/sulfamethoxazole (SXT), amoxicillin with clavulanic acid (AmC-30), and oxacillin (OX-1) antibiotic discs used as controls. Thep values were less than 0.0001 by one-way analysis of variance (ANOVA). Silver-nZeo particles that were embedded in agar wells yielded slightly larger zones of inhibition (11.08±0.89 mm), thus indicating greater silver diffusion than in silver-nZeo aqueous suspension applied to the agar surface. Additionally, well-embedded silver-nZeo particles that were wetted exhibited significantly (p<0.0001) larger inhibition zones (11.83±0.47 mm) than surface-applied silver-nZeo aqueous suspensions (8.58±0.50 mm). The nZeos not subjected to silver ion exchange did not inhibit MRSA.

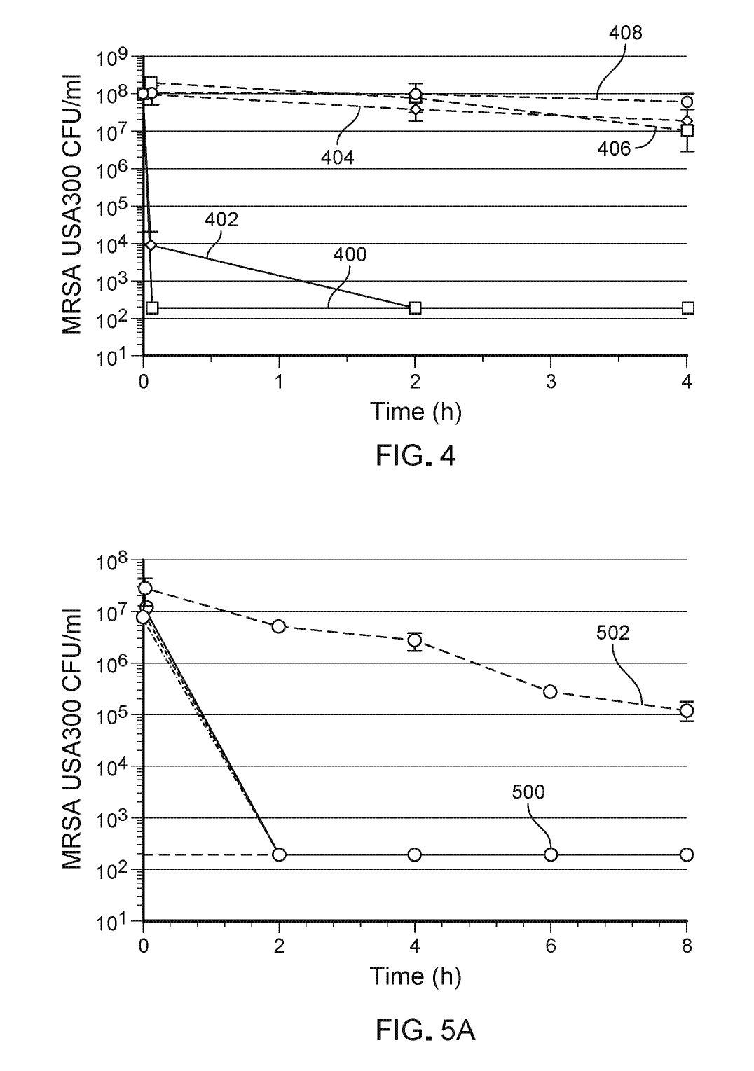

The effect of nZeo and silver-nZeo on the growth of MRSA was investigated by performing in vitro antimicrobial susceptibility experiments in aqueous suspensions. Results are shown in FIG. 4. After addition of 1 or 10 mg of the materials, small aliquots were immediately collected to determine viability, and the suspensions were incubated at 37° C. for 4 h. Immediate exposure (2 min) of MRSA to silver-nZeo resulted in rapid bactericidal activity with complete killing or 99.99% reduction with 10 mg/mL and 1 mg/mL of silver-nZeo particles, as shown in plots 400 and 402 in FIG. 4, respectively (detection limit 200 CFU/mL; values represent the mean CFU and S.D. of three independent experiments). In contrast, as shown by plots 404 (1 mg/mL nZeo), 406 (10 mg/mL nZeo), and 408 (control-0 mg/mL nZeo) not subjected to silver ion exchange did not significantly affect MRSA viability.

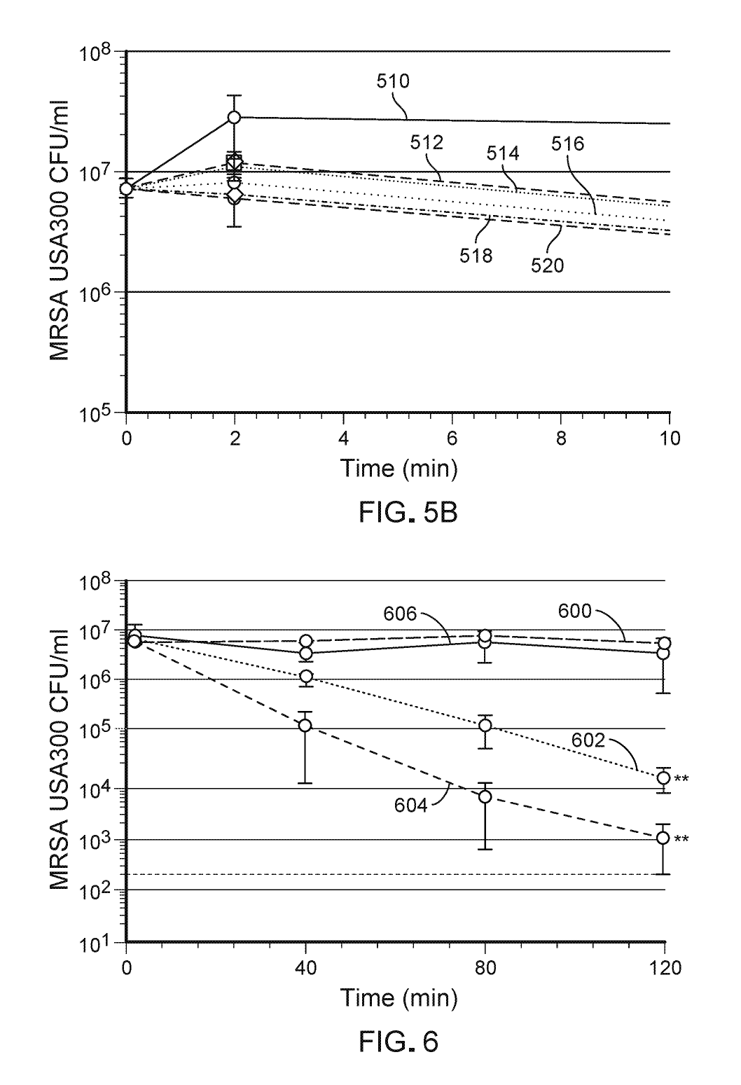

Since 1 mg of silver-nZeo particles killed MRSA within 2 h, MRSA was exposed to microgram quantities of the silver-nZeo particles to determine the minimum inhibitory concentration. Results are shown in FIGS. 5A and 5B. Incubation of MRSA to 1, 2.5, 5, 10, or 100 μg/mL suspensions of silver-nZeos resulted in complete killing within 2 h, as shown in plot 500, which represents overlapping data for these suspensions. Plot 502 shows viability for a 0 μg/mL control. Plots 510-520 in FIG. 5B show MRSA viability upon immediate exposure (2 min) to microgram quantities (0 μg/mL, 1 μg/mL Ag⁺-nZeo, 2.5 μg/mL Ag⁺-nZeo, 5 μg/mL Ag⁺-nZeo, 10 μg/mL Ag⁺-nZeo, and 100 μg/mL Ag⁺-nZeo, respectively) of the silver-nZeos. In FIGS. 5A and 5B, values represent the mean CFU and S.E.M. of three independent experiments, and the detection limit was 200 CFU/mL.

To determine the minimum bactericidal concentration (MBC), MRSA was incubated with 0.1, 0.5, and 1 μg/mL suspensions of silver-nZeo for 120 min, and viability was determined every 40 min. Results are shown in plots 600, 602, and 604, respectively, in FIG. 6, with values representing the mean CFU and S.E.M. of three independent experiments. Plot 606 is a control (0 μg/mL). The detection limit was 200 CFU/mL (**p<0.005 by two-way ANOVA).

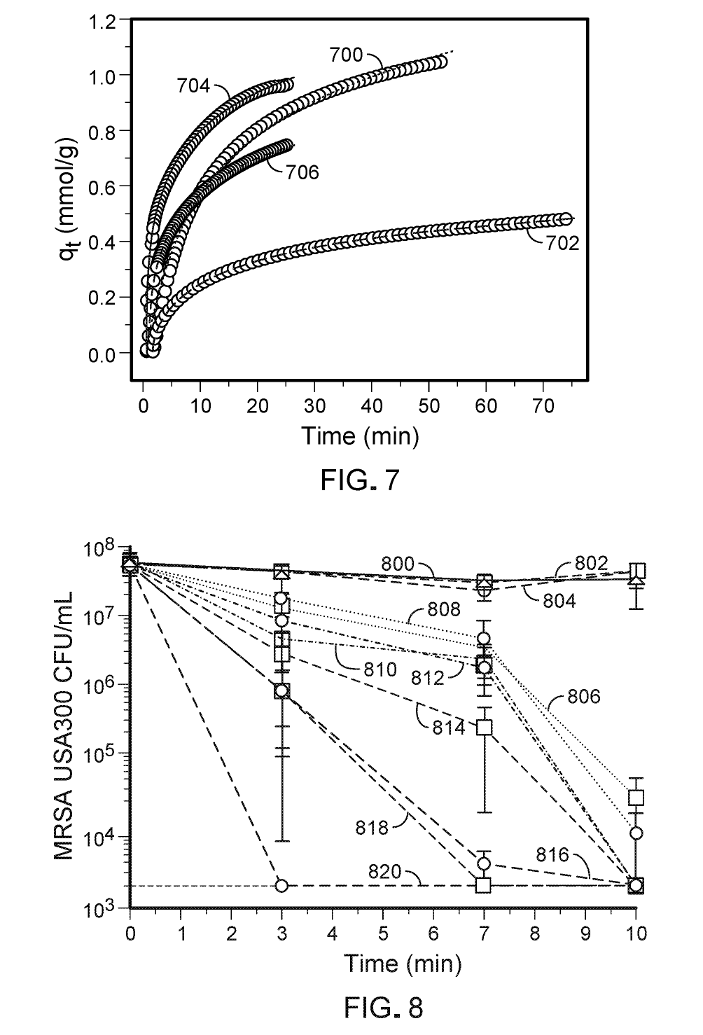

Silver release kinetics. To study the efficiency of the silver release by Na⁺ ion exchange, a flow system was set up with a zero-length column as the sample chamber through which Na⁺ ion solution was passed at a constant rate to the receiving beaker where the released silver ion concentration was continuously measured with a silver ion-selective electrode (ISE). Both ends of the sample chamber were closed with nanoporous membrane filter (200 nm pores) in order to prevent accidental release of the sample particles. About 100 mg of silver-nZeo and silver-mZeo were exposed to 0.9 wt % NaNO₃ influent solution at flow rates of 1.2 and 5.0 mL/min. These rates are on the order of the typical values that are used in administering intravenous (IV) infusions ( 0.5-3 mL/min). FIG. 7 shows the release curves for two different samples (silver-nZeo and silver-mZeo) at the two different flow rates. Various kinetics models were examined to describe the experimental data, including the zeroth-order, first-order, pseudo first-order, second-order, pseudo second-order and Elovich models. Plots 700 and 702 correspond to silver-nZeo and silver-mZeo, respectively, for a flow rate of 1.2 mL/min. Plots 704 and 706 correspond to silver-nZeo and silver m-Zeo, respectively, for a flow rate of 5.0 mL/min. Plots 700-706 are fitted with the Elovich model, shown as a solid line within each plot.

In summary, it was found that silver-nZeo inhibits MRSA in agar diffusion assays and rapidly kills MRSA in in vitro suspensions. Moreover, microgram quantities of silver-nZeos rapidly kill MRSA in in vitro suspensions. Incubation of MRSA in dH₂O with 1 μg/mL Ag-nZeo, which correlates to 0.24 μg/mL Ag (due to 24% Ag-loading capacity), for 2 h resulted in a 99.98% reduction and established the Ag-nZeo MBC in water. For reference to clinical microbials, MRSA was then incubated with 2-fold serial dilutions of Ag-nZeo ( 0.25-1024 μg/mL) for 24 h in CAMHB. This revealed MIC and MBC values of 4 μg/mL Ag-nZeo (Ag equivalency of 0.96 μg/mL). Susceptibility testing of MRSA in TSB revealed similar 24 h MIC and MBC values of 16 and 32 μg/mL Ag-nZeo (3.8 and 7.7 μg/mL Ag), respectively.

To investigate correlation between the silver ion release kinetics and the antibacterial performance of silver-nZeo and silver-mZeo, kill curve experiments were performed with MRSA in the presence of sodium sulfate (1.1%) in the first 10 min period during which the two materials show the largest difference in the ion release kinetics. Results are shown in FIG. 8, with plots 800-820 corresponding to 0 μg/mL mZeo and nZeo (control), 400 μg/mL mZeo (control), 400 μg/mL nZeo (control), 50 μg/mL Ag-mZeo (12.1 μg/mL Ag), 50 μg/mL Ag-nZeo (12.0 μg/mL Ag), 100 μg/mL Ag-mZeo (24.1 μg/mL Ag), 100 μg/mL Ag-nZeo (23.9 μg/mL Ag), 200 μg/mL Ag-mZeo (48.2 μg/mL Ag), 200 μg/mL Ag-nZeo (47.8 μg/mL Ag), 400 μg/mL Ag-mZeo (96.4 μg/mL Ag), 400 μg/mL Ag-nZeo (95.6 μg/mL Ag), respectively.

At 3 min, 400 μg/mL silver-nZeo (plot 820) displayed rapid bactericidal activity (>99.99% population reduction), while 400 μg/mL silver-mZeo (plot 818) and 200 μg/mL silver-nZeo (plot 816) reduced the bacterial population only by approximately 95%. After 7 min, 200 μg/mL silver-nZeo (plot 816) displayed bactericidal activity (99.99% population reduction), while the corresponding silver-mZeo (plot 814) showed a 99% population reduction. After 10 min incubations, all concentrations of silver-nZeo and silver-mZeo tested exhibited rapid bactericidal activity.

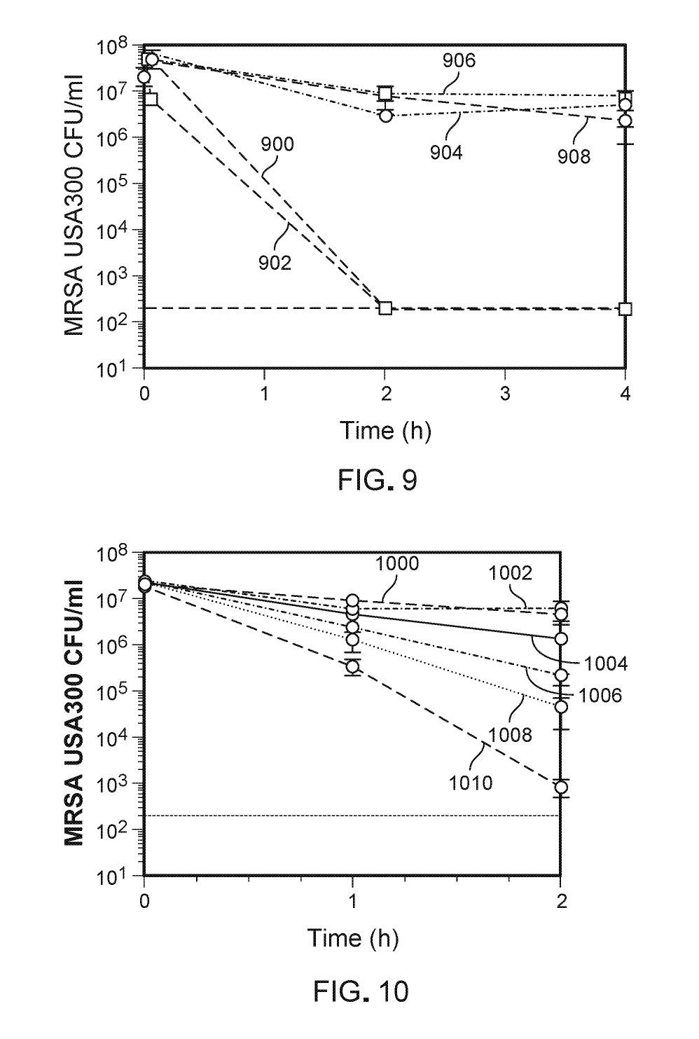

The effects of nZeo and copper-nZeo on the growth of MRSA were investigated by performing in vitro antimicrobial susceptibility experiments in saline suspensions. After addition of 1 or 10 mg of the materials, small aliquots were immediately collected to determine viability, and the suspensions were incubated at 37° C. for 4 h. Exposure of MRSA to 1 mg/mL and 10 mg/mL copper-nZeo resulted in bactericidal activity within 2 h, as shown in plots 900 and 902, respectively, of FIG. 9. In contrast, nZeo not subjected to copper ion exchange did not significantly affect MRSA viability, as shown in plots 904, 906, and 908 (1 mg/mL nZeo, 10 mg/mL nZeo, and 0 mg/mL nZeo (control), respectively.

To determine the minimum bactericidal concentration (MBC) (defined as a 99.9% reduction in viable cell counts), MRSA was incubated with two-fold decreasing concentrations of copper-nZeo saline suspensions. Plots 1000, 1002, 1004, 1006, 1008, and 1010 in FIG. 10 show viability for concentrations of 0 μg/mL, 4, μg/mL, 8 μg/mL, 16 μg/mL, 32 μg/mL, and 64 μg/mL, respectively. Incubation of MRSA with 64 μg/mL copper-nZeo for 2 h (plot 910) resulted in a 99.98% reduction and establishes the copper-nZeo MBC in sterile saline.

In summary, it was found that copper-nZeo rapidly kills MRSA in in vitro saline suspensions and the minimum bactericidal concentration (MBC) of copper-nZeo against MRSA is 64 μg/mL. This value correlates to 4.5 μg/m1 Cu, considering the relative amount of Cu (7 wt %) in copper-nZeo.

Only a few implementations are described and illustrated. Variations, enhancements and improvements of the described implementations and other implementations can be made based on what is described and illustrated in this document.

1. An antimicrobial composition comprising porous aggregates, the porous aggregates comprising aluminosilicate nanoparticles, wherein the porous aggregates contain one or more of alkaline earth metals, rare earth metals, Mn, Fe, Co, Ni, Ag, Cu, Zn, Hg, Sn, Pb, Bi, Cd, Cr, and Tl in metallic form, ionic form, or a combination thereof.

2. The antimicrobial composition of claim 1, wherein an average particle size of the aluminosilicate nanoparticles is between about 5 nm and about 100 nm.

3. The antimicrobial composition of claim 1, wherein a majority of the pores between the aluminosilicate nanoparticles in the porous aggregates have a pore width between about 2 nm and about 100 nm.

4. The antimicrobial composition of claim 1, wherein a majority of the porous aggregates have a particle size between about 50 nm and about 10μm.

5. The antimicrobial composition of claim 1, wherein a majority of the porous aggregates have a particle size between about 50 nm and about 1 μm.

6. The antimicrobial composition of claim 1, wherein the mesopore volume of the porous aggregates is at least about 0.05 cc/g, at least about 0.1 cc/g, at least about 0.2 cc/g, or at least about 0.3 cc/g on the Barrett, Joyner and Halenda (BJH) cumulative pore volume from the desorption branch of the N₂ sorption isotherm, wherein the mesopore volume is the total pore volume of the pores having a pore width from about 2 to about 100 nm.

7. The antimicrobial composition of claim 1, wherein the mesopore volume of the porous aggregates contributes at least about 10%, at least about 30%, at least about 50%, at least about 70%, or at least about 90% of the total pore volume of the aggregates from the pores having a pore width between about 2 nm and about 100 nm based on the Barrett, Joyner and Halenda (BJH) cumulative pore volume from the desorption branch of the N₂ sorption isotherm.

8. The antimicrobial composition of claim 1, wherein the specific external surface area of the porous aggregates is between about 10 m²/g and about 300 m²/g, wherein the specific external surface area of the porous aggregates is the total specific surface area minus the specific micropore surface area.

9. The antimicrobial composition of claim 1, wherein the specific micropore surface area of the porous aggregates is between about 100 m²/g and about 700 m²/g, and the aluminosilicate defines zeolitic micropores.

10. (canceled)

11. (canceled)

12. The antimicrobial composition of claim 1, wherein the porous aggregates are formed by a process comprising:
providing a geopolymer resin containing up to about 85 mol % water;
optionally keeping the geopolymer resin at a temperature up to about 60° C. for up to about a week;
optionally heating the geopolymer resin in a closed container at a temperature up to about 120° C. for up to about a week to yield a semi-liquid or a semi-solid;
treating the semi-liquid or the semi-solid to form a dispersion or suspension comprising the porous aggregates and reducing the pH of the dispersion or suspension to a range from about 3 to about 12; and
optionally concentrating a solid component or collecting a solid product from the dispersion or suspension.

13. The antimicrobial composition of claim 12, wherein the geopolymer resin comprises organic molecules.

14. The antimicrobial composition of claim 12, wherein the geopolymer resin comprises an ester, an organic carboxylate, an organic carboxylic acid, or a combination thereof.

15. The antimicrobial composition of claim 12, wherein the aluminosilicate nanoparticles define zeolitic micropores.

16. (canceled)

17. The antimicrobial composition of claim 1, wherein the aluminosilicate nanoparticles comprise about 0.1 wt % to about 30 wt % of one or more metal ions selected from the group consisting of Ag, Cu, and Zn ions.

18. The antimicrobial composition of claim 1, wherein the porous aggregates contain silver, and the silver-containing porous aggregates release at least 33% of the contained silver within about 30 minutes when in contact with 0.9 wt % NaNO₃ solution flowing at 1.2 mL/min.

19. The antimicrobial composition of claim 1, wherein the porous aggregates contain silver, and the silver-containing porous aggregates release at least 33% of the contained silver within about 10 minutes when in contact with 0.9 wt % NaNO₃ solution flowing at 5.0 mL/min.

20. The antimicrobial composition of claim 1, wherein the porous aggregates contain silver, and the silver-containing porous aggregates show a minimum bactericidal concentration (MBC) value equivalent to no greater than about 0.3 μg or about 1 μg of Ag per mL within about 2 hours, or a MBC value equivalent to no greater than about 1 μg or about 10 μg of Ag per mL within about 24 hours for methicillin-resistant Staphylococcus aureus (MRSA).

21. The antimicrobial composition of claim 1, wherein the porous aggregates contain silver, and the silver-containing porous aggregates show a minimum inhibitory concentration (MIC) value equivalent to no greater than about 2 μg of Ag per mL within about 2 hours, or the MBC value equivalent to no greater than about 1 μg or about 10 μg of Ag per mL within about 24 hours for methicillin-resistant Staphylococcus aureus (MRSA).

22. The antimicrobial composition of claim 1, wherein the porous aggregates contain copper, and the copper containing porous aggregates show a minimum bactericidal concentration (MBC) value equivalent to no greater than about 10 μg or about 100 μg of Cu per mL within about 2 hours, or a MBC value equivalent to no greater than about 2000 μg of Cu per mL within about 24 hours for methicillin-resistant Staphylococcus aureus (MRSA).

23-25. (canceled)

26. The antimicrobial composition of claim 1, wherein the antimicrobial composition reduces contamination of fomites by viral pathogens selected from the group consisting of Swine influenza (H1N1), H3N2, H2N2, Avian influenza A (H5N1), Avian influenza A (H9N2), Equine influenza (H3N8), Influenza B, Human coronaviruses, Feline infectious peritonitis virus (FIPV), Feline calicivirus F-9, Hepatitis A virus, Hepatitis B virus, SARS (Severe Acute Respiratory Syndrome) coronavirus, HIV-1, Respiratory syncytial virus, Coliphage MS2, Poliovirus, Rotavirus, Adenovirus, Murine norovirus, Lactobacillus case phage PL-1, and Human norovirus (calicivirus).

27. (canceled)
